(19) United States
(12) Patent Application Publication
(10) Pub. No.: US 2024/0383788 A1
(43) Pub. Date: Nov. 21, 2024

(54) WATER TREATMENT METHOD AND WATER TREATMENT APPARATUS

(71) Applicant: ORGANO CORPORATION, Tokyo (JP)

(72) Inventors: Yudai SUZUKI, Tokyo (JP); Fumio SUDO, Tokyo (JP); Nau MORITA, Tokyo (JP)

(73) Assignee: ORGANO CORPORATION, Tokyo (JP)

(21) Appl. No.: 18/688,828

(22) PCT Filed: Aug. 2, 2022
(86) PCT No.: PCT/JP2022/029681

§ 371 Date: Mar. 4, 2024

(30) Foreign Application Priority Data
Sep. 6, 2021 (JP) 2021-144780

(51) Int. Cl. C02F 9/00; B01D 61/02; B01D 61/04; B01D 61/08; C02F 1/44; C02F 1/66; C02F 5/08; C02F 101/14

(52) U.S. Cl. CPC C02F 9/00; B01D 61/026; B01D 61/04; B01D 61/08; B01D 2311/04; C02F 1/441; C02F 1/66; C02F 5/08; C02F 2101/14; C02F 2209/001; C02F 2209/40; C02F 2301/08

(57) ABSTRACT

As a countermeasure for calcium fluoride scale in reverse osmosis membranes, a water treatment method and apparatus are provided that can add a scale inhibitor at an appropriate addition amount. A water treatment apparatus for treating water to be treated that contains fluorine and calcium by passing the water through at least a reverse osmosis membrane includes pH adjustment means for adjusting the pH of the water to be treated in a supply line, means for measuring the concentration of fluoride ions in the water to be treated and then determining the amount of scale inhibitor to be added by an addition means based on the measured fluoride ion concentration. After the scale inhibitor is added from an addition line, permeate from a permeate line and concentrate from a concentrate line are discharged from the reverse osmosis membrane.

### TECHNICAL FIELD

The present invention relates to a water treatment method and a water treatment apparatus including a reverse osmosis membrane apparatus in which scale adhesion is suppressed.

### BACKGROUND ART

In recent years, reverse osmosis membranes have been increasingly used in water treatment. Water subject to water treatment (called water to be treated) contains various components, which are precipitated (called scale) due to various factors. This decrease the reverse osmosis membrane flux and leads to a decrease in processing efficiency. Scale precipitation (scaling) is one of the important factors in the operation management of reverse osmosis membranes. In particular, scaling by calcium is the most common, and scaling by calcium carbonate and calcium fluoride are known.

In foreign countries such as Hong Kong, Singapore, Malaysia, Ireland, the United States, Australia, New Zealand and the United Kingdom, fluoride is added to the tap water supply to maintain dental health. Furthermore, surface water from overseas has a higher concentration of hardness components than that from Japan. Therefore, in the above-mentioned countries, there is a concern about the precipitation of scale by calcium fluoride in pure water production.

In Patent Document 1, a method of lowering the pH of the water to be treated to 4-6 is proposed as a scale countermeasure by calcium carbonate. On the other hand, in Patent Document 2 or Patent Document 3, the application of a scale inhibitor is proposed as a scale countermeasure by calcium fluoride.

### PRIOR ART DOCUMENTS

### Patent Documents

### Patent Document 1: JP-2018-153732-A

### Patent Document 2: JP-2014-184365-A

### Patent Document 3: JP-2002-186835-A

### SUMMARY OF THE INVENTION

### Technical Problem

In recent years, water shortages have led to an increase in water demand for treating and using various types of water. The concentration of scale components in concentrated water has increased due to the resulting increase in water recovery. Therefore, the added concentration of scale inhibitors is increasing, and the increase in the operating cost of water treatment equipment has become a problem. As a measure against conventional scale, a fixed amount of scale inhibitor was injected in a fixed amount through preliminary tests and water quality analysis. However, if the water quality fluctuates greatly in the water treatment process, the increase in running costs is a problem when scale inhibitors are added in excess. In particular, scale inhibitors are expensive, and the cost burden cannot be ignored. On the other hand, if the scale inhibitor is added too little, scale adhesion of the reverse osmosis membrane cannot be sufficiently prevented, and the replacement time of the reverse osmosis membrane is shortened.

Furthermore, as shown in Patent Document 3, calcium fluoride precipitation is less on the acidic side with low pH, and scale inhibitors are not used or the amount of scale inhibitor used can be reduced. However, low pH conditions can cause corrosion of pipes and other components, resulting in another cost increase for corrosion prevention linings.

Accordingly, an object of the present invention is to provide a water treatment method and a water treatment apparatus that optimizes running costs by adding an appropriate amount of scale inhibitor at a moderate pH.

### Means for Solving the Problem

In the present invention it is provided a water treatment method for treating water to be treated containing fluorine and calcium by passing the treated water through at least a reverse osmosis membrane, which comprises:

a step of measuring the fluoride ion concentration in the water to be treated;

a step of adding a scale inhibitor that suppresses the precipitation of calcium fluoride; and

a reverse osmosis membrane treatment step of obtaining permeate water and concentrated water by passing the scale inhibitor and the water to be treated after addition to the reverse osmosis membrane;

wherein the fluoride ion concentration in the water to be treated is measured after the pH is adjusted to 5 or higher, and the amount of scale inhibitor added is determined based on the measured fluoride ion concentration.

Furthermore, in the present invention it is provided a water treatment apparatus comprises

a reverse osmosis membrane that passes water to be treated containing fluorine and calcium to obtain permeate water and concentrated water, and

a supply water line that supplies the water to be treated to the reverse osmosis membrane,

the water supply line comprises:

means for adjusting the pH of the water to be treated;

means for measuring the concentration of fluoride ions in the water to be treated at pH of 5 or higher; and

means for adding a scale inhibitor to the water to be treated to suppress precipitation of calcium fluoride;

wherein a water treatment apparatus comprises an addition amount control apparatus that determines the amount of scale inhibitor added by the addition means based on the measured fluoride ion concentration and controls the amount of scale inhibitor added in the addition means.

### Effect of the Invention

According to this invention, it is possible to provide a water treatment method and a water treatment apparatus that can add an appropriate amount of a scale inhibitor at a moderate pH.

### BRIEF DESCRIPTION OF THE DRAWINGS

FIG. 1 It is a schematic diagram explaining the configuration of a water treatment apparatus according to a first embodiment of the present invention.

FIG. 2 It is a schematic diagram explaining the configuration of a water treatment apparatus according to a second embodiment of the present invention.

FIG. 3 It is a graph explaining the relationship between the detection amount ratios of calcium fluoride detected in Examples and Comparative Examples.

### MODE FOR CARRYING OUT THE INVENTION

The present invention provides a water treatment method and a water treatment apparatus for treating the water to be treated containing fluorine and calcium with a reverse osmosis membrane. Here, the water to be treated includes surface water of rivers and lakes, tap water, and industrial water. The water to be treated in the present invention is used for ultrapure water production applications and the like.

With reference to the drawings, the embodiment of the invention is described below.

### First Embodiment

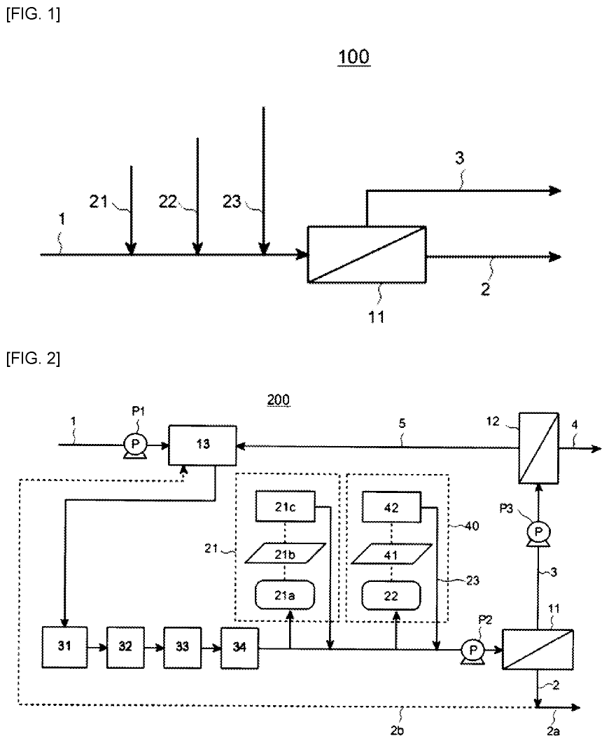

FIG. 1 is a schematic diagram explaining the configuration of a water treatment apparatus according to a first embodiment of the present invention.

The water treatment apparatus 100 in the present embodiment is an apparatus for generating the water to be treated by removing impurities (fluoride ions, calcium ions, and the like) contained in the treated water, and has a reverse osmosis membrane 11 that separates concentrate water containing impurities and permeate water from which impurities have been removed.

Further, the water treatment apparatus 100 has a plurality of lines each connected to the reverse osmosis membrane 11. In other words, the water treatment apparatus 100 includes a supply water line 1 that supplies water to be treated to a reverse osmosis membrane, a permeate water line 2 that drains permeated water from the reverse osmosis membrane 11, and a concentrate water line 3 that drains concentrate water from the reverse osmosis membrane 11. In addition, the supply water line 1 includes a pH adjustment apparatus 21 as a pH adjustment means, a measurement means (fluoride ion meter) 22 for measuring the concentration of fluoride ions, and an addition line 23 as a means for adding a scale inhibitor.

Although the decarboxylation process is not shown in the present embodiment, the decarboxylation process may be provided in front of the pH adjustment apparatus 21 in order to suppress the scale of calcium carbonate and improve the quality of permeated water. In this case, the treated water in the above process often has a pH<5.0. When the treated water is pH<5.0, fluoride ion become partly hydrogen fluoride according to the divergence curve of hydrogen fluoride. For example, at pH=5.0, the amount of fluoride ions that become hydrogen fluoride is almost negligible at about 1%. However, at pH=4.5, about 4.5% of fluoride ions become hydrogen fluoride, at pH=4.0, about 13% of fluoride ions become hydrogen fluoride, and at pH=3.5, about 32% of fluoride ions become hydrogen fluoride. Fluoride ion that have become hydrogen fluoride contribute to the formation of calcium fluoride as the pH rises due to the equilibrium reaction between hydrogen fluoride and fluoride ions. However, fluoride ions that have become hydrogen fluoride cannot be measured with a fluoride ion meter. Therefore, the fluoride ions concentration in the water to be treated changes depending on the pH at the time of measurement with a fluoride ion meter. The amount of scale inhibitor added calculated from the fluoride ions concentration at low pH results in an insufficient addition, and the scale cannot be suppressed sufficiently.

Therefore, the fluoride ion concentration is measured under a condition that the pH is 5.0 or higher Specifically, the pH adjustment apparatus 21 provides a pH adjustment step so that the water to be treated has a pH≥5.0. This prevents some of the fluoride ions from becoming hydrogen fluoride, and the fluoride ion concentration of the water to be treated in the supply water line 1 can be accurately measured by the fluoride ion meter 22. In the pH adjustment apparatus 21, a chemical injection method that does not affect fluoride ions in the water to be treated is selected, and an alkali, in particular a low-concentration sodium hydroxide aqueous solution, is added. In addition to the means of adding alkali, the pH adjustment apparatus has pH measuring means such as a pH meter to measure the pH of the water to be treated at least either before or after the addition of the alkali.

Furthermore, in the scale precipitation of calcium fluoride, the reason for measuring the fluoride ion concentration rather than the calcium ion concentration is explained below. Calcium fluoride scale precipitation is determined by the product of the molar concentrations of fluoride ions and calcium ions (hereafter, referred to as ion product). The solubility product of calcium fluoride is 3.9×10⁻¹¹ (mol³/L³). If the ionic product exceeds this solubility product value, scale is precipitated. Calcium fluoride is composed of calcium and fluoride ions in a molar ratio of 1:2. The ion product Kap of calcium fluoride is expressed by the following formula (1).

$$Kap = [ C {a}^{+} ] ( {[ {F}^{-} ]}^{2} ) \qquad Formula ( 1 )$$

In Formula (1), [Ca+] is the calcium ion concentration and [F] is the fluoride ion concentration.

The ion product Kap of calcium fluoride is calculated by the product of the square of the fluoride ion concentration and the calcium ion concentration. For this reason, the fluoride ion concentration has a greater effect on the ion product than the calcium ion concentration. From the above, it is more effective to monitor fluoride ions than calcium ions when determining the amount of scale inhibitor to be added based on ion product from fluctuating water quality.

The lower limit of measurement quantitation of a typical fluoride ion meter is about 1 mg/L. When the fluoride ion concentration is 20 mg/L or less, the fluctuation of ionic product exceeds about 10% when the fluoride ion concentration fluctuates by 1 mg/L. For this reason, this method is particularly effective in the areas where the fluoride ion concentration is 20 mg/L or less. Furthermore, the calcium ion concentration at that time is 1.4 mg/L or more because the ion product is equal to or greater than the solubility product of calcium fluoride. This method is even more effective when the fluoride ion concentration is 10 mg/L or less, because the ion product fluctuates by 20% or higher. Furthermore, the calcium ion concentration at that time is 5.6 mg/L or more.

Based on the results of the fluoride ion concentration measurement and the recovery rate (sometimes called the concentration factor) calculated from the first and second flow rates measured by the first and second flow sensors (not shown) connected to any two of the supply water line 1, permeate water line 2, and concentrate water line 3, the amount of scale inhibitor added is determined in real time. As a result, it does not take time from the analysis to the determination of the amount of scale inhibitor added. Normally, when the flow rate of the supply water line 1 is 100, the total flow rate of the permeate water line 2 and the concentrated water line 3 is also 100. The recovery rate is the amount of permeated water relative to the water to be treated and is set to, for example, 75% as the performance of the reverse osmosis membrane. However, in the actual water treatment operation, fluctuations in the amount of permeated water and the amount of concentrated water occur due to fluctuations in the water quality and water temperature of the water to be treated. Therefore, by measuring the actual amount of water, when measuring the fluoride ion concentration, it is not affected by fluctuations in the amount of permeated water and the amount of concentrated water due to fluctuations in water quality and water temperature, and accurate fluoride ions concentrations can be measured, and an appropriate amount of scale inhibitors can be determined. Here, “amount of addition of an appropriate scale inhibitor” in the present invention is preferably the minimum necessary addition amount from the viewpoint of avoiding excessive addition of an expensive scale inhibitor.

Based on the determined amount of scale inhibitor added, a scale inhibitor is added from the scale inhibitor addition line 23.

The scale inhibitor is not limited to a specific substance as long as it can suppress the precipitation of scale components such as silica and calcium. However, a scale inhibitor that suppresses the precipitation of calcium fluoride is particularly preferred. The types include phosphonic acid compounds such as 1-hydroxyethylidene-1,1-diphosphonic acid, 2-phosphonobutane-1,2,4-tricarboxylic acid, ethylenediamine tetramethylene phosphonic acid, nitrilotrimethylphosphonic acid, and phosphonic acid compounds such as their salts; phosphoric acid compounds such as orthophosphates and polymerized phosphates; maleic acid compounds such as polymaleic acid and copolymers of maleic acid; acrylic acid polymers, and the like. Acrylic acid polymers include copolymers such as poly (meth) acrylic acid, maleic acid/(meth) acrylic acid, (meth) acrylic acid/sulfonic acid, (meth) acrylic acid/monomer containing nonionic group, and terpolymer such as (meth) acrylic acid/sulfonic acid/monomers containing nonionic groups, (meth) acrylic acid/acrylamide-alkyl sulfonic acid/substituted (meth) acrylamide, (meth) acrylic acid/acrylamide-arylsulfonic acid/substituted (meth) acrylamide acrylamide, etc. Examples of the (meth) acrylic acid constituting the terpolymer include methacrylic acid, acrylic acid, and (meth) acrylates such as their sodium salts. Examples of the acrylamide-alkyl sulfonic acid constituting the terpolymer include 2-acrylamide-2-methylpropanesulfonic acid such as their sodium salts. Examples of the substituted (meth) acrylamide constituting the terpolymer include t-butylacrylamide, t-octylacrylamide, and dimethylacrylamide.

Among these, it is preferable to use one containing at least one of a phosphonic acid compound and an acrylic acid polymer. For example, copolymers composed of acrylic acid and 2-acrylamido-2-methylpropanesulfonic acid are preferred. In order to simultaneously inhibit scale derived from calcium and silica, it is particularly preferable to use a scale inhibitor agent comprising a mixture of 2-phosphonobutane-1,2,4-tricarboxylic acid, acrylic acid, and terpolymer of (Meth)acrylic acid/2-acrylamido-2-methylpropanesulfonic acid/substituted (meth)acrylamide.

In particular, commercially available scale inhibitor for reverse osmosis membranes include “Orpersion” series manufactured by Organo Corporation, “Flocon (registered trademark)” series manufactured by BWA Water Additives Corporation, “Per maTreat (registered trademark)” series manufactured by Nalco Corporation, “Hypersperse (registered trademark)” series manufactured by General Electric Corporation, “Kuriverter (registered trademark)” series manufactured by Kurita Water Industries.

The addition of a scale inhibitor can be performed in the pH range in which calcium fluoride precipitates. Usually, calcium fluoride begins to precipitate at a pH of 3.5 or higher. In the embodiment shown in FIG. 1, the pH of the water to be treated is adjusted to 5 or higher to measure the fluoride ion concentration between the pH adjustment apparatus 21 and the reverse osmosis membrane 11. After the pH of the water to be treated is adjusted to 5 or higher, fluoride ions are measured and scale inhibitors are added. In order to improve the water quality of the permeate water of the reverse osmosis membrane, the pH is preferably 4 or higher, and more preferably 5 or higher. Therefore, it is preferable to adjust the pH in front of (upstream) of the reverse osmosis membrane 11.

FIG. 1 shows an example in which the fluoride ion concentration measurement means is arranged downstream of the pH adjustment means, however, it is not limited to this. If the pH of the water to be treated is 5 or higher before the treatment to reduce the pH value such as a decarboxylation tower, a measuring means for measuring fluoride ion concentration can be arranged upstream of the pH adjustment means. Furthermore, it is also preferable to provide a pH meter and the like to confirm that the water to be treated is pH 5 or higher.

### Second Embodiment

FIG. 2 is a schematic diagram explaining the configuration of a water treatment apparatus according to a second embodiment of the present invention. Hereinafter, the configuration as in the first embodiment is denoted by the same reference numerals in the figures and the description thereof is omitted, and only the configuration different from the first embodiment will be described.

As in the first embodiment, it has a supply water line 1 that supplies the water to be treated and a reverse osmosis membrane 11. The water treatment apparatus 200 of the second embodiment has a water supply tank 13 that stores the water to be treated to be passed through, the pretreatment (coagulation and filtration) apparatus 31, a heat exchanger 32, an activated carbon tower (activated carbon filter) 33, a decarboxylation tower 34, a reverse osmosis membrane 11, and a brine reverse osmosis membrane 12 in the supply water line 1.

The storage volume in the water supply tank 13 is adjusted by the pressurizing pump P1 (pressure adjustment regulating means) that adjusts the pressure of the water to be treated flowing through the supply water line. Furthermore, the water supply tank 13 can return the permeated water after permeation of the reverse osmosis membrane 11 from the permeate water line 2 via the circular flow line 2b as well as from the supply water line 1. The permeate water after filtration treatment of concentrated water separated by reverse osmosis membrane 11 with brine reverse osmosis membrane 12 can also flow in by circulation line 5. However, since the permeate water after passing through the reverse osmosis membrane 11 may be collected, in that case, it is not circulated to the water supply tank 13, but is collected via the water collection line 2a. The concentrated water in the brine reverse osmosis membrane 12 is drained from the drainage line 4 and is disposed of after post-treatment as necessary.

Pretreatment apparatus 31 includes equipment capable of coagulation, sand filtration, and membrane filtration. The flocculation treatment is a process in which the charge of fine particles in water that are negatively charged by a positively charged flocculant is neutralized and agglomerated to produce a basal floc, and the base floc is adsorbed by a flocculation aid such as a polymer to generate a coarse floc to make it easier to precipitate. Flocculants include aluminum sulfate, polyaluminum chloride, ferric chloride, ferrous sulfate, etc. Sand filtration is a process in which sedimented sand is used as a filter material and water is filtered by passing water through the sedimented sand. Membrane filtration is the process of filtering water by passing it through a filtration membrane. Filtration membranes include microfiltration (MF) membranes, ultrafiltration (UF) membranes, nanofiltration (NF) membranes, ion exchange membranes, etc., depending on the size of the substance to be filtered and the driving force for filtration.

The heat exchanger 32 is an apparatus for heating the water to be treated supplied after pretreatment, and is provided for generating hot water for heat sterilization.

The activated carbon tower 33 is provided for removing chlorine from the water to be treated supplied from the heat exchanger.

The decarboxylation tower 34 is an apparatus that converts carbonate ions or bicarbonate ions into carbon dioxide gas by lowering the pH by injecting acid, and removes carbonic acid in water by blowing air into the filling tower. It is provided for suppression of calcium carbonate scale and improvement of permeate water quality.

The second embodiment is basically the same as the first embodiment from the decarboxylation tower 34 to the reverse osmosis membrane 11, and includes a pH adjustment apparatus 21, a fluoride ion meter 22, and a scale inhibitor addition line 23. The pH adjustment apparatus 21 has a pH control apparatus 21b that determines the amount of pH adjuster (alkali) added in the pH adjuster addition apparatus 21c based on the pH value measured by the pH meter 21a and the pH meter 21a, which are pH measurement means. A predetermined amount of pH adjuster (alkali) is added from the pH adjuster addition apparatus 21c controlled by the pH controller 21b, pH of the treated water is adjusted to 5.0 or higher. At this time, a flowmeter as described in the first embodiment is placed upstream of the pH adjuster 21, and the measured flow rate and pH value can be input to the pH controller 21b to set the amount of pH adjuster to be added in real time. In addition, a pH meter is installed downstream of the pH adjustment apparatus. A pH adjuster corresponding to the difference between the front and back pH meters may be added. The water to be treated with pH adjusted in this way is collected, and the fluoride ion concentration is measured with a fluoride ion meter 22. The measured fluoride ion concentration is transferred to the scale inhibitor addition amount control apparatus 41 and the minimum required amount of scale inhibitor is calculated. Based on that information, a scale inhibitor is added from the scale inhibitor adding apparatus 42 to the supply water line 1 via the scale inhibitor addition line 23. In this example, the scale inhibitor addition means 40 includes a fluoride ion meter 22, a control apparatus 41, an addition apparatus 42, and an addition line 23.

Furthermore, after the scale inhibitor is added from scale inhibitor addition line 23, the pressure is adjusted by pressurizing pump P2 (pressure adjustment means) and water is passed through to reverse osmosis membrane 11.

Thus, if the fluoride ion concentration is measured at the pH once lowered in the decarboxylation tower 34, the amount of scale inhibitor added based on the measured fluoride ion concentration will be under-added when the scale inhibitor is added after the pH is subsequently raised, and scale adhesion of the reverse osmosis membrane cannot be sufficiently prevented. Therefore, in the present embodiment, the fluoride ion concentration is measured by the fluoride ion meter 22 after the pH is increased to 5.0 or higher in the pH adjustment apparatus 21. Based on that value, scale adhesion of the reverse osmosis membrane can be sufficiently prevented even if the amount of scale inhibitor added from scale inhibitor addition line 23 is kept to the minimum necessary. The installation location of the fluoride ion meter 22 is not limited to the downstream of the pH adjustment apparatus 21 shown in FIG. 2, and can be installed in any supply water line having a pH of 5.0 or higher. For example, the permeate water of the reverse osmosis membrane 11 and the permeate water of the brine reverse osmosis membrane 12 have a pH of 5.0 or higher, and the water to be treated in the water supply tank 13 circulated and mixed with the surface water may also have a pH of 5.0 or higher. Therefore, an online fluoride ion meter (not shown) is installed in the supply water line 1 in the water supply tank 13 or in front of the pretreatment apparatus downstream thereof, and the measured fluoride ion concentration is contacted to the addition amount control apparatus 41.

The permeated water after passing water through the reverse osmosis membrane 11 may be collected through the permeate water line 2 or circulated to the water supply tank 13 without collecting water.

On the other hand, the concentrated water after passing through the reverse osmosis membrane 11 is passed through the concentrated water line 3 to the brine reverse osmosis membrane 12, with the pressure adjusted by the pressurizing pump P3 (pressure adjustment means) in the concentrated water line 3. After filtration through the brine reverse osmosis membrane 12, the water is separated into wastewater that is drained through drain line 4 and circulating water that is circulated to the water supply tank 13.

### EXAMPLES

Next, the effects of the invention will be explained with specific examples.

### Example 1

Simulated water containing fluoride ions and calcium ions was prepared using pure water as raw water in a 1 L beaker. The pH at the time of adjustment was adjusted to 3.5. Hydrochloric acid or sodium hydroxide solution was used for pH adjustment. The calcium ion concentration was adjusted with calcium chloride to 200 mg/L. PH was adjusted to 5.0 and then the fluoride ion concentration was measured (F ion measured value) with a fluoride ion meter. The scale inhibitor was added according to the addition amount of the scale inhibitor calculated from the measured fluoride ion concentration. Copolymers consisting of acrylic acid and 2-acrylamido-2-methylpropanesulfonic acid were used as scale inhibitors. An ion electrode (model number: F-2021) manufactured by Toa DKK Corporation was used to measure fluoride ion concentration. After the addition of the scale inhibitor, the amount of calcium fluoride precipitated was calculated after stirring for 24 hours using a magnetic stirrer. The method for calculating the amount of calcium fluoride precipitation is described below. The supernatant solution after the test was filtered using a 0.1 μm filter and the pH was adjusted to 6.0-7.0. Then the fluoride ion concentration was t measured. The fluoride ion concentration consumed for scale precipitation was calculated from the measurements result and the fluoride ion concentration before the test. The amount of calcium fluoride precipitation was calculated from these results.

### Example 2

The amount of calcium fluoride precipitation was calculated in the same manner as in Example 1, except that the simulated water was adjusted to pH 4.0.

### Example 3

The amount of calcium fluoride precipitation was calculated in the same manner as in Example 1, except that the simulated water was adjusted to pH 4.5.

### Example 4

Simulated water was prepared at pH 5.0. The amount of calcium fluoride precipitated was calculated in the same manner as in Example 1, except that the fluoride ion concentration was measured at the same pH.

### Example 5

Simulated water was prepared at pH 5.5. The amount of calcium fluoride precipitated was calculated in the same manner as in Example 1, except that the fluoride ion concentration was measured at the same pH.

### Comparative Example 1

Simulated water prepared in the same manner as in Example 1 was used. Before measuring fluoride ions with a fluoride ion meter, the pH was not adjusted to 5.0. The fluoride ion concentration was measured (F ion measured value) with the pH at 3.5. The scale inhibitor was added according to the amount of scale inhibitor added calculated from the measured fluoride ion concentration. Otherwise, the amount of calcium fluoride precipitated was calculated in the same manner as in Example 1.

### Comparative Example 2

Simulated water prepared in the same manner as in Example 2 was used. Before measuring fluoride ions with a fluoride ion meter, the pH was not adjusted to 5.0. The fluoride ion concentration was measured (F ion measured value) with the pH at 4.0. The scale inhibitor was added according to the amount of scale inhibitor added calculated from the measured fluoride ion concentration. Otherwise, the amount of calcium fluoride precipitated was calculated in the same manner as in Example 1.

### Comparative Example 3

Simulated water prepared in the same manner as in Example 3 was used. Before measuring fluoride ions with a fluoride ion meter, the pH was not adjusted to 5.0. The fluoride ion concentration was measured (F ion measured value) with the pH at 4.5. The scale inhibitor was added according to the amount of scale inhibitor added calculated from the measured fluoride ion concentration. Otherwise, the amount of calcium fluoride precipitated was calculated in the same manner as in Example 1.

Table 1 shows the detection amount ratio (Comparative Example/Example) of calcium fluoride between each Example and each Comparative Example. In Table 1, fluoride ions are shown as “F ions,” calcium ions are shown as “Ca ions,” and calcium fluoride is shown as “CaF2.”

TABLE 1

| | | | | | F ion | Amount | | | Amount ratios of |
|---|---|---|---|---|---|---|---|---|---|
| | F ion | C ion | pH when | pH when | meter | of scale | Amount | Amount | CaF2 detected |
| | concen- | concen- | preparing | measured | measurement | inhibitor | of F ion | of CaF2 | [Comparison |
| | tration | tration | simulated | with F ion | value | added | consumption | detected | Example/ |
| No. | [mg/L] | [mg/L] | water | meter | [mg/L] | [mg/L] | [mg/L] | [mg/L] | Example] |
| Example 1 | 6.7 | 200 | 3.5 | 5.0 | 6.64 | 40.0 | 0.082 | 0.17 | 1.94 |
| Comparative Example 1 | | | | 3.5 | 4.52 | 27.2 | 0.161 | 0.33 | |
| Example 2 | | | 4.0 | 5.0 | 6.64 | 40.0 | 0.529 | 1.09 | 1.68 |
| Comparative Example 2 | | | | 4.0 | 5.78 | 34.8 | 0.891 | 1.83 | |
| Example 3 | | | 4.5 | 5.0 | 6.64 | 40.0 | 1.124 | 2.31 | 1.11 |
| Comparative Example 3 | | | | 4.5 | 6.34 | 38.2 | 1.253 | 2.57 | |
| Example 4 | | | 5.0 | 5.0 | 6.64 | 40.0 | 1.161 | 2.38 | 1.00 |
| Example 5 | | | 5.5 | 5.5 | 6.64 | 40.0 | 1.175 | 2.41 | 1.00 |

14

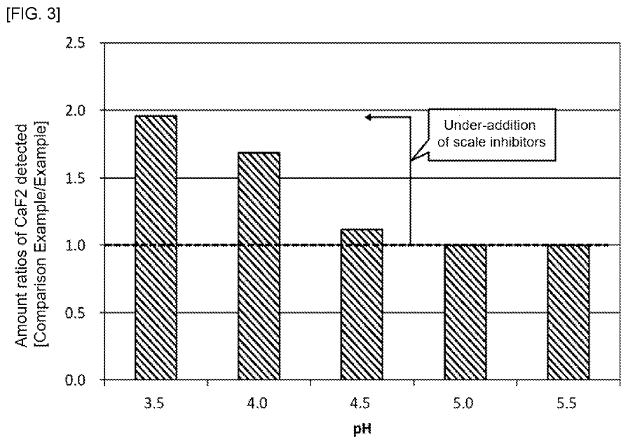

FIG. 3 is a graph showing the relationship between the detection amount ratio (Comparative Example/Example) of calcium fluoride detected in Example and Comparative Example. In the pH <5., it can be seen that the scale inhibitor is under-added. In Examples 4 and 5, the detection amount ratio is 1.00. The amount of CaF2 precipitation is lower at lower pH. Assuming that the scale inhibitor is added at pH≥5, an increase in scale corresponding to the deficiency indicated by the detection volume ratio can be predicted.

Although the present invention has been described with reference to the example embodiment, the present invention is not limited to the example of the above embodiment. Various changes can be made to the configuration and details of the present invention that can be understood by those skilled in the art within the scope of the present invention.

This application asserts priority based on the Japan Patent Application No. 2021-144780 filed on Sep. 6, 2021, and incorporates all of its disclosures herein.

The present invention includes the following method.

### [Method 1]

A water treatment method for treating water to be treated containing fluorine and calcium by passing the treated water through at least a reverse osmosis membrane, which comprises:

a step of measuring the fluoride ion concentration in the water to be treated;

a step of adding a scale inhibitor that suppresses the precipitation of calcium fluoride; and

a reverse osmosis membrane treatment step of obtaining permeate water and concentrated water by passing the scale inhibitor and the water to be treated after addition to the reverse osmosis membrane;

wherein the fluoride ion concentration in the water to be treated is measured after the pH is adjusted to 5 or higher, and the amount of scale inhibitor added is determined based on the measured fluoride ion concentration.

### [Method 2]

The water treatment method according to [Method 1], wherein the addition of the scale inhibitor is performed after adjusting the pH of the water to be treated to 5 or higher.

### [Method 3]

The water treatment method according to [Method 1] or [Method 2], wherein the pH adjustment is performed by adding a pH adjuster to a water supply line that supplies the water to be treated to the reverse osmosis membrane,

the measurement of the fluoride ion concentration is performed in the feed water line after adding the pH adjuster.

### [Method 4]

The water treatment method according to [Method 3], wherein the first flow rate and the second flow rate are measured in any two of the supply water line, the permeate water line from the reverse osmosis membrane, and the measured fluoride ion concentration, the amount of the scale inhibitor added is determined from the recovery rate obtained from the comparison between the first flow rate and the second flow rate and the measured fluoride ion concentration.

### [Method 5]

The water treatment method according to [Method 3] or [Method 4], wherein a decarboxylation step is presented to remove a carbonic acid component in the water to be treated before adding a pH adjuster to the supply water line.

Furthermore, the present invention includes the following configurations.

### [Configuration 1]

A water treatment apparatus comprises

a reverse osmosis membrane that passes water to be treated containing fluorine and calcium to obtain permeate water and concentrated water, and

a supply water line that supplies the water to be treated to the reverse osmosis membrane,

the water supply line comprises:

means for adjusting the pH of the water to be treated;

means for measuring the concentration of fluoride ions in the water to be treated at pH of 5 or higher; and

means for adding a scale inhibitor to the water to be treated to suppress precipitation of calcium fluoride;

wherein a water treatment apparatus comprises an addition amount control apparatus that determines the amount of scale inhibitor added by the addition means based on the measured fluoride ion concentration and controls the amount of scale inhibitor added in the addition means.

### [Configuration 2]

The water treatment apparatus according to [Configuration 1], wherein the water treatment apparatus comprises a first flow sensor for measuring a first flow rate and a second flow sensor for measuring a second flow rate in any two of the supply water line, permeate water from the reverse osmosis membrane, and concentrated water line from the reverse osmosis membrane, respectively,

the addition amount control apparatus determines the amount of the scale inhibitor added from the recovery rate obtained from the comparison between the first flow rate and the second flow rate and the fluoride ion concentration measured by the measurement means.

### [Configuration 3]

The water treatment apparatus according to [Configuration 1] or [Configuration 2], wherein the supply water line includes a decarboxylation tower for removing a carbonic acid component in the water to be treated upstream of the pH adjustment means.

### [Configuration 4]

The water treatment apparatus according to any one of [Configuration 1] to [Configuration 3], further comprising:

a brine reverse osmosis membrane for further treating concentrated water of the reverse osmosis membrane;

a water supply tank for mixing permeate water of the brine reverse osmosis membrane and/or permeate water of the reverse osmosis membrane with the water to be treated in the supply water line.

### [Configuration 5]

The water treatment apparatus according to any one of [Configuration 1] to [Configuration 4], wherein means for measuring is arranged downstream of means for adjusting the pH.

### EXPLANATION OF SIGNS

1 Supply water line
2 Permeate water line
3 Concentrate water line
4 Drainage line
5 Circulation line
11 Reverse osmosis membrane
12 Brine reverse osmosis membrane
13 Water supply tank
21 PH adjustment apparatus
21a PH meter
21b PH controller
21c PH adjuster addition apparatus
22 Fluoride ion meter
23 Scale inhibitor addition line
31 Pretreatment (coagulation and filtration) apparatus
32 Heat exchanger
33 Activated carbon tower
34 Decarboxylation tower
40 Scale inhibitor addition means
41 Scale inhibitor addition amount control apparatus
42 Scale inhibitor addition apparatus
100, 200 Water treatment apparatus
P1 1st pump
P2 2nd pump
P3 3rd pump

1. A water treatment method for treating water to be treated containing fluorine and calcium by passing the treated water through at least a reverse osmosis membrane, which comprises:
measuring the fluoride ion concentration in the water to be treated;
adding a scale inhibitor that suppresses the precipitation of calcium fluoride; and
obtaining permeate water and concentrated water by passing the scale inhibitor and the water to be treated after addition to the reverse osmosis membrane;
wherein the fluoride ion concentration in the water to be treated is measured after the pH is adjusted to 5 or higher, and the amount of scale inhibitor added is determined based on the measured fluoride ion concentration.

2. The water treatment method according to claim 1, wherein the addition of the scale inhibitor is performed after adjusting the pH of the water to be treated to 5 or higher.

3. The water treatment method according to claim 1, wherein the pH adjustment is performed by adding a pH adjuster to a water supply line that supplies the water to be treated to the reverse osmosis membrane,
the measurement of the fluoride ion concentration is performed in the feed water line after adding the pH adjuster.

4. The water treatment method according to claim 3, wherein the first flow rate and the second flow rate are measured in any two of the supply water line, the permeate water line from the reverse osmosis membrane, and the measured fluoride ion concentration, the amount of the scale inhibitor added is determined from the recovery rate obtained from the comparison between the first flow rate and the second flow rate and the measured fluoride ion concentration.

5. The water treatment method according to claim 3, wherein a decarboxylation is presented to remove a carbonic acid component in the water to be treated before adding a pH adjuster to the supply water line.

6. A water treatment apparatus comprises:
a reverse osmosis membrane that passes water to be treated containing fluorine and calcium to obtain permeate water and concentrated water; and
a supply water line that supplies the water to be treated to the reverse osmosis membrane,
the water supply line comprises:
means for adjusting the pH of the water to be treated;
means for measuring the concentration of fluoride ions in the water to be treated at pH of 5 or higher; and
means for adding a scale inhibitor to the water to be treated to suppress precipitation of calcium fluoride,
wherein a water treatment apparatus comprises an addition amount control apparatus that determines the amount of scale inhibitor added by the addition means based on the measured fluoride ion concentration and controls the amount of scale inhibitor added in the addition means.

7. The water treatment apparatus according to claim 6, wherein the water treatment apparatus comprises a first flow sensor for measuring a first flow rate and a second flow sensor for measuring a second flow rate in any two of the supply water line, permeate water from the reverse osmosis membrane, and concentrated water line from the reverse osmosis membrane, respectively,
the addition amount control apparatus determines the amount of the scale inhibitor added from the recovery rate obtained from the comparison between the first flow rate and the second flow rate and the fluoride ion concentration measured by the measurement means.

8. The water treatment apparatus according to claim 6, wherein the supply water line includes a decarboxylation tower for removing a carbonic acid component in the water to be treated upstream of the pH adjustment means.

9. The water treatment apparatus according to claim 6, further comprising:
a brine reverse osmosis membrane for further treating concentrated water of the reverse osmosis membrane; and
a water supply tank for mixing permeate water of the brine reverse osmosis membrane and/or permeate water of the reverse osmosis membrane with the water to be treated in the supply water line.

10. The water treatment apparatus according to claim 6, wherein means for measuring is arranged downstream of means for adjusting the pH.
